(19) United States
(12) Patent Application Publication
(10) Pub. No.: US 2023/0031060 A1
(43) Pub. Date: Feb. 2, 2023

(54) METHOD AND SYSTEM FOR MONITORING THE PERFORMANCE OF A VOICE RECOGNITION ASSISTANCE SYSTEM IN A DATA SENSITIVE ENVIRONMENT

(71) Applicant: HARMAN INTERNATIONAL INDUSTRIES, INCORPORATED, Stamford, CT (US)

(72) Inventor: Alexander Alexandrovich BOROCHKIN, Nizhni Novgorod (RU)

(21) Appl. No.: 17/850,891

(22) Filed: Jun. 27, 2022

(30) Foreign Application Priority Data
Jul. 29, 2021 (RU) 2021122623

(51) Int. Cl. G10L 15/01

(52) U.S. Cl. CPC G10L 15/01

(57) ABSTRACT

The disclosure relates to a method and system for monitoring the performance of a voice recognition (VR) assistance system in a data sensitive environment, wherein the VR assistance system comprises one or more client devices and a server, the server comprising a monitoring component. The method comprises determining, by at least one client device, client input data; processing, by the VR assistance system, the client input data; determining, by the monitoring component, one or more anonymized performance indicators of the VR assistance system; determining, by the monitoring component, one or more anonymized performance indicator values for the one or more anonymous performance indicators during the processing of the client input data; outputting and/or saving, by the monitoring component, the determined one or more anonymized performance indicator values.

### CROSS-REFERENCE TO RELATED APPLICATIONS

This application claims the priority of co-pending Russian patent application titled, “METHOD AND SYSTEM FOR MONITORING THE PERFORMANCE OF A VOICE RECOGNITION ASSISTANCE SYSTEM IN A DATA SENSITIVE ENVIRONMENT” filed on Jul. 29, 2021 and having Serial No. 2021122623. The subject matter of this related application is hereby incorporated herein by reference

### BACKGROUND

### Field of the Various Embodiments

The present disclosure relates to the processing of voice recognition data. In particular, the disclosure relates to methods and systems for monitoring the performance of voice recognition assistance system, more particularly in a data sensitive environment.

### Description of the Related Art

Voice recognition (VR) assistance systems are widely used in an increasing number of applications. The demands regarding the performance of VR assistance systems with respect to language recognition, language use and content recognition are high. Users expect that VR assistance systems perform at a similar service level as human professionals at help desks or cabin steward employees.

In order to improve the performance of VR assistance systems, performance metrics including reply performance, request intensity, power capacity or knowledge base need to be monitored. To this end, current VR assistance systems collect and store data and compute aggregated statistics based on these data. However, the data usually contain personal information of the user. Thus, by regulation, the user has the option to suspend personal data collection. If the user selects this option, the data are not available for statistical evaluation of the VR assistance system performance.

Therefore, the present disclosure provides a method and system for monitoring the performance of a voice recognition (VR) assistance system in a data sensitive environment. According to the present disclosure anonymized data are aggregated during data processing by the VR assistance system, allowing to create a performance evaluation of the VR assistance system using only aggregated data.

### SUMMARY

A first aspect of the present disclosure relates to a method for monitoring the performance of a voice recognition (VR) assistance system in a data sensitive environment, wherein the VR assistance system comprises one or more client devices and a server, the server comprising a monitoring component. The method comprises (i) determining, by at least one client device of the one or more client devices, client input data; (ii) processing, by the VR assistance system, the client input data; (iii) determining, by the monitoring component, one or more anonymized performance indicators of the VR assistance system; (iv) determining, by the monitoring component, one or more anonymized performance indicator values for the one or more anonymous performance indicators during the processing of the client input data; and (v) outputting and/or saving, by the monitoring component, the determined one or more anonymized performance indicator values.

The objective of the method is to monitor the performance of a VR assistance system in a data sensitive environment. Input data of a client are determined and processed. The input may be received by a VR microphone of one or more client devices, such as mobile phones or dedicated VR devices. The processing of the client input data by the VR assistance system may comprise speech-to-text transcription, natural language processing and/or text-to-speech transcription. Anonymized performance indicators of the VR assistance system and values of these indicators are determined during data processing. Additionally or alternatively, the anonymized performance indicators of the VR assistance system may be predetermined. Anonymized performance indicators may comprise indicators of at least parts of a client request or client input data, at least parts of the replies of the VR assistance system to the client, recognition errors or technical issues. Further, the anonymized performance indicators may comprise indicators of the number, type or language of the activation of the VR assistance system or details of the power usage of the VR assistance systems among others. The values of the anonymized performance indicators may include counts, amounts of data or processing times. The determined values of the anonymized performance indicators can be stored or output. The stored indicators may be used for comparison to indicators stored at a different time or using a different version of a VR assistance system; the output may be used for the identification of error sources during the performance of the VR assistance systems and to improve the system. As only anonymized performance indicators are used, no personal data of a user are assembled and processed. Thus, the method does not rely on the permission of the user. However, the method may comprise an option to enable the use of personal user data for the monitoring of the performance of the VR assistance system. This option would allow for a customized performance monitoring and would enable subsequent use of these customized data for a tailored performance improvement.

Furthermore, by determining the one or more anonymized performance indicator values for the one or more anonymous performance indicators during the processing of the client input data, the monitoring of the system is enhanced, more particular the monitoring speed is increased. In that manner, monitoring results can be output and processed earlier, e.g. approximately in real time, which results in an increased efficiency of the monitoring method.

According to an embodiment, the one or more anonymous performance indicators are consistent with predetermined general data protection regulations. Thereby it is assured that no personal client data are used for the determination of the performance indicators and its values. In that manner, the security of the monitoring method is enhanced.

According to another embodiment, determining, by the monitoring component, one or more anonymized performance indicator values comprises increasing one or more performance indicator counters, in particular, a plurality of respective counters for a plurality of time intervals. Increasing counters of performance indicators further enables anonymized data processing. For example, the number of activations of the VR assistance system via wakeup word or via button during one day or one week may be counted. As another example, the number of queries by a client to the VR assistance system during one conversation may be counted. Using such counters enables monitoring the use and/or performance of the VR assistance system without allowing personal inferences and/or wherein personal user data such as location, time and exact audio input of the user are irrelevant.

According to an embodiment, the one or more performance indicator counters are indicative of a processing efficiency of the VR assistance system, processing time of the VR assistance system, reply performance of the VR assistance system, processing errors of the VR assistance system, a client device and/or a server capacity and/or power usage. Determining several performance indicator counters in several categories enables monitoring of different performances in the different categories of the VR assistance system. For example, measures indicating the performance of the VR assistance system during the conversation with a client, including the number of dialog transitions, the number of queries or the duration of the conversation, may be monitored. In another example, the technical VR assistance system performance including network traffic or server time may be monitored. Thereby, information about the technical performance or content performance may be stored or output and used for the improvement of the respective categories of the VR assistance system.

According to another embodiment, the one or more performance indicator counters are indicative of a client device usage behavior, a request intensity of the one or more client devices, one or more client input data types, and/or client device software and/or hardware performance. Thereby, indications of the client satisfaction and resulting use frequency of the VR assistance system may be determined. Further, for example, the client device platform and software or hardware performance may be monitored. This allows improving compatibility of the VR assistance system to several platforms or enables determining whether outsourcing of computation processes from the VR assistance system to the client device may be advantageous.

According to an embodiment, the method further comprises comparing, by the monitoring component, the one or more performance indicator values to one or more previously determined performance indicator values and/or previously determined performance indicator threshold values. Comparing performance indicators values to previously determined ones allows monitoring trends, for example, after activating a new version of the VR assistance systems. For example, the performance of the system in a particular category such as recognition of a wakeup word for system activation of a first version and a second version of the VR assistance system may be compared. Thereby, indications of the improvement of the system may be extracted. The comparison of the performance indicator values to previously determined thresholds may enable extracting indications of malfunctions of the VR assistance system out of predetermined system requirements. For example, an allowable number of repetitions of a user query until the VR assistance system creates an appropriate response may be predefined. Subsequently, a response may be output by the system if this number is exceeded.

According to another embodiment, the method further comprises: generating, by the VR assistance system, client output data based on the processed client input data, outputting, by the client device, the client output data; and deleting, by the VR assistance system, the client input data and the client output data.

Generating client output data based on the processed client input data may comprise speech-to-text transcription, natural language processing and text-to-speech transcription. The respective answer, i.e. the client output data, by the VR assistance system to the user are then output via the client device. The client input and output data may comprise personal information about the user. Thus, after generating and outputting the client output data, both the client input data and the client output data are deleted. In an example, a typical time period for maintaining the data within the AR assistance system may be 5 sec. By deleting the client input data and the client output data and/or any intermediate data, in particular directly after having processed the client input data or output the client output data, data security of the monitoring method is further increased.

According to another embodiment, the monitoring component is comprised in a separate docker container on the server. The monitoring component may be accessed via an internal private network interface. The separation of the monitoring component form other components of the server allows for flexible implementation of the component to different server environments and may further increase data security.

According to another embodiment, the VR assistance system is a multi-language VR assistance system, in particular wherein the one or more performance indicator counters are indicative of an occurrence of a language of the client input data. Supported languages may include English, German, French and Spanish among others. Enabling the system to identify a multitude of languages broadens the field of applications, for example to include touristic environments. Implementing performance indicators which are indicative of the occurrence of the language may enable monitoring the use environments of the system, and allows to increase the counters individually for each language. Thereby, the performance of the VR assistance system may be monitored disentangled from the used language as well as in dependence on the used language.

A second aspect of this disclosure relates to a monitoring component for use in a voice recognition (VR) assistance system, wherein the monitoring component is configured to: determine one or more anonymized performance indicators of the VR assistance system; determine, one or more anonymized performance indicator values for the one or more anonymous performance indicators during processing of client input data by the VR assistance system; and output and/or saving the determined one or more anonymized performance indicator values.

The monitoring component may be part of the server of a VR assistance system. The monitoring component determines the anonymized performance indicators and its values. The monitoring component then outputs or saves the determined anonymized performance indicator values. The values may be stored to a database on the server or a database in the monitoring component. Stored data may be used for comparison of performance indicator values determined during different time intervals. Thereby, the performance of different versions of the VR assistance system may be monitored and compared. The values may, alternatively, be output by the monitoring component. This output may contain indications for performance improvement.

According to an embodiment, the one or more anonymous performance indicators are consistent with predetermined general data protection regulations. Thereby it is assured that no personal client data are used for the determination of the performance indicators and its values.

According to an embodiment, to determine one or more anonymized performance indicator values comprises to increase one or more performance indicator counters, in particular a plurality of respective counters for a plurality of time intervals. Increasing counters of performance indicators further enables anonymized data processing. For example, the number of activations of the VR assistance system via wakeup word or via button during one day or one week may be counted. As another example, the number of queries by a client to the VR assistance system during one conversation may be counted.

According to an embodiment, the one or more performance indicator counters are indicative of a processing efficiency of the VR assistance system, processing time of the VR assistance system, reply performance of the VR assistance system, processing errors of the VR assistance system, a client device and/or a server capacity and/or power usage. For example, measures indicating the performance of the VR assistance system during the conversation with a client, including the number of dialog transitions, the number of queries or the duration of the conversation, may be monitored. In another example, the technical VR assistance system performance, including network traffic or server time may be monitored.

According to an embodiment, the one or more performance indicator counters are indicative of a client device usage behavior, a request intensity of the one or more client devices, one or more client input data types, and/or client device software and/or hardware performance. For example, the client device platform and software or hardware performance may be monitored.

According to an embodiment, the monitoring component is further configured to compare the one or more performance indicator values to one or more previously determined performance indicator values and/or previously determined performance indicator threshold values. For example, performance indicator values at different days of a week or performance indicator values of different version of a VR assistance system may be compared. In another example, performance indicator values may be compared to predetermined system requirement thresholds.

According to an embodiment, the monitoring component is comprised in a separate docker container on the server. The monitoring component may be accessed via an internal private network interface.

A third aspect of the disclosure relates to a voice recognition (VR) assistance system, the VR assistance system comprising one or more client devices; and a server, the server comprising a monitoring component; wherein the VR assistance system is configured to perform the above disclosed method. The one or more client devices may comprise devices containing a VR microphone such as mobile phones or dedicated VR devices. The server may comprise, in addition to the monitoring component, containers for speech-to-text transcription, natural language processing and/or text-to-speech transcription. The monitoring component may be comprised in a separate container. The server may further comprise a controller. The components and containers of the server may communicate through an internal private network. All properties of the method of the present disclosure also apply to the system.

### BRIEF DESCRIPTION OF THE DRAWINGS

The features, objects, and advantages of the present disclosure will become more apparent from the detailed description set forth below when taken in conjunction with the drawings in which like reference numerals refer to similar elements.

FIG. 1 depicts a flow chart of a method for monitoring the performance of a voice recognition assistant;

FIG. 2 depicts an example output of performance indicator values of a query recognition performance of the VR assistance system generated by the method;

FIG. 3 depicts an example output of performance indicator values of the processing time of the VR assistance system generated by the method; and

FIG. 4 depicts a block diagram of a system for monitoring the performance of a voice recognition assistance system.

### DETAILED DESCRIPTION

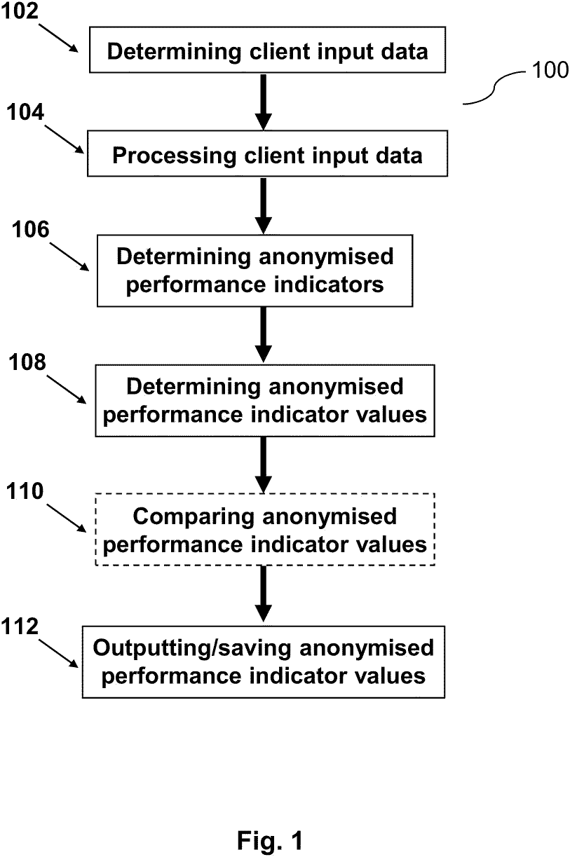

FIG. 1 depicts a flow chart of a method 100 for monitoring the performance of a voice recognition assistance system in a data sensitive environment. In a preferred embodiment, the system is a multi-language VR assistance system. In step 102, client input data are determined by at least one client device. The client input data may comprise audio data containing a query by a user of the VR assistance system. The client input data are then processed by the VR assistance system in step 104. To this end, at least a part of the client input data may be transferred to a server of the VR recognition system. In order words: The client input data may be processed by the client device and/or the server. The input data processing may comprise speech-to-text transcription, natural language processing and text-to-speech transition. The client input data may comprise personal information about the user of the VR assistance system such as time, location, device ID as well as personal information contained in the audio data such as user voice and personal content. In a preferred embodiment, the VR assistance system generates a response, i.e. client output data and this response is output via the client device. For data security, the client input and output data are deleted after the output.

In step 106, the monitoring component of the VR assistance system determines one or more anonymized performance indicators of the VR assistance system. These performance indicators do not rely on personal information of the user. In a preferred embodiment, the performance indicators are in accordance with predetermined general data protection regulations. In step 108, the monitoring component determines one or more anonymized performance indicator values for the one or more anonymous performance indicators during the processing of the client input data. In a preferred embodiment, the determination of the performance indicator values comprises increasing one or more performance indicator counters. Such counters may be increased during a predetermined time period and/or using input data of several client devices.

In a preferred embodiment, the method further comprises comparing performance indicator values to previously determined one or predetermined threshold values in step 110.

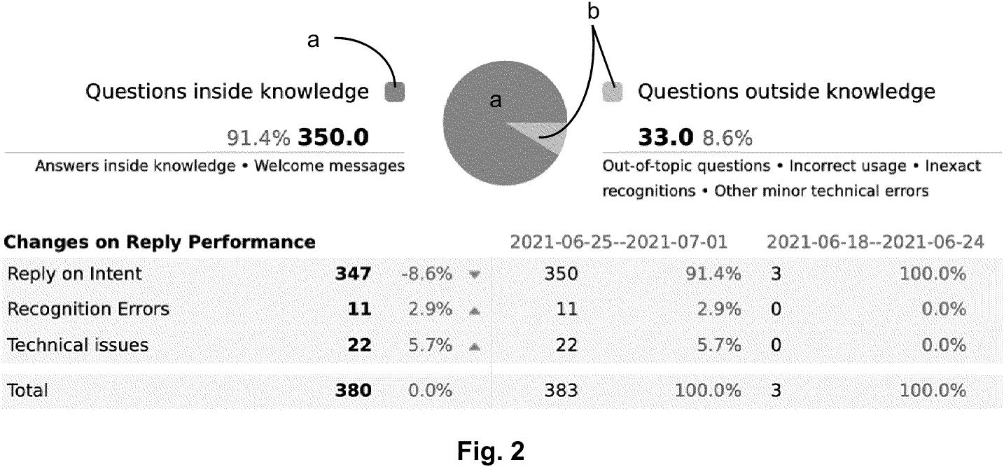

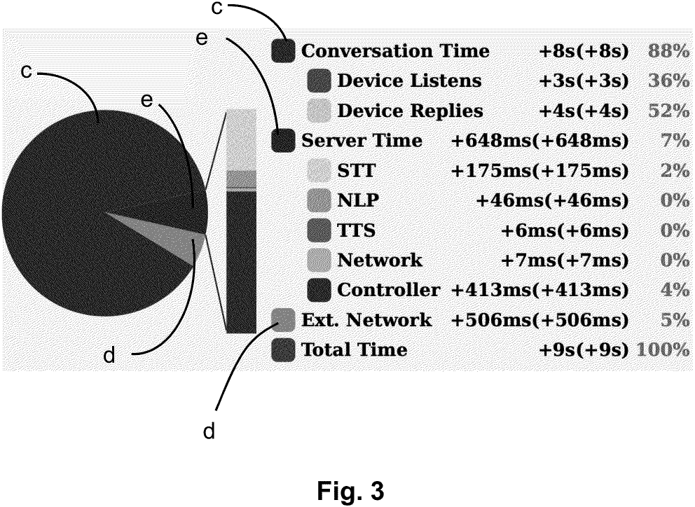

The determined one or more anonymized performance indicator values are output or stored by the monitoring component in step 112. The output may comprise for example, performance indicator values, comparisons of performance indicator values determined during different time periods or trigger signals based on the performance indicator values or comparisons of performance indicator values. Example outputs are shown in FIGS. 2 and 3 and described below. The determined performance indicators may alternatively or additionally be stored in a database and access by the monitoring component later, e.g. for value comparisons.

Example anonymized performance indicators and values comprises categories regarding the VR performance efficiency, such as performance rates of reply, recognition error, technical issues, performance rate changes between two data sets, for example determined at different times. An example output of anonymized performance indicator values for these categories is shown in FIG. 2. Performance indicators may also comprise usage indicators such as number of activations within a predetermined time period, the activation type (wakeup word, button or proactive conversation) and/or activation language in case of a multi-language VR assistance system. For multi-language voice recognition system, in a preferred embodiment, performance indicator values may be counted for each language individually. Further, additional performance indicators may be determined compared to a single-language VR assistance system, such as performance efficiency across languages, number of device activations across languages, distribution of requests across languages. For example, determining of the performance indicator values may include increasing counters for the number of activations.

Further, the performance indicators may comprise VR system power indicators including total number of activations, number of activations per device, time of conversations, network traffic, server time and/or client devices. Indicators of the client device may include indicators of the number of client devices connected to the VR assistance system, the operating system of the client devices.

An example output of anonymized performance indicator values of the processing time of the VR assistance system is shown in FIG. 3. For example, determining of the performance indicator values may include increasing counters indicative of the conversation time or server processing time.

Further, the indicators may include the VR system knowledge via dialog flows, number of transitions within a dialog, most frequent questions and/or most frequent query topics. The indicators may also include hardware usage comprising load of CPU, memory, HDD, NetHDD and/or Swap.

The created output may be distributed using a subscription service. In particular, the monitoring component may generate an output containing performance indicator values as shown in FIGS. 2 and 3. This output may be converted to html or PDF format and send via an admin user interface to a predetermined list of subscribers via e-mail in direct copy, carbon copy or blind carbon copy. The distributed output may contain all or selected performance indicator values.

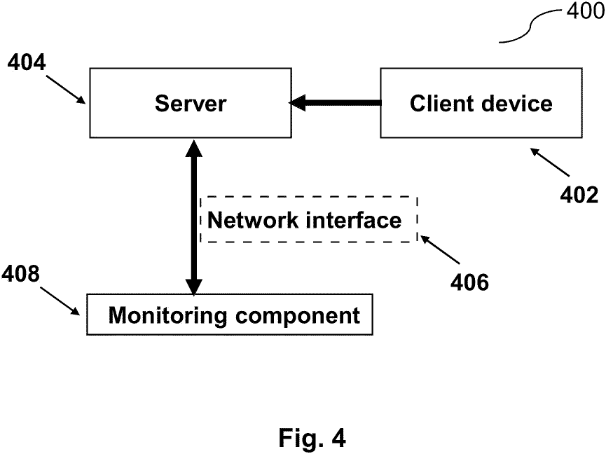

FIG. 4 depicts a block diagram of a system 400 for monitoring the performance of a voice recognition assistance system. The system 400 comprises one or more client devices 402 for capturing a user query and determining client input data. In a preferred embodiment, the one or more client devices may comprise mobile phones, VR devices or other devices with a suitable microphone and speaker. The system further comprises a server 404. The server comprises a monitoring component 408 which is access via a network interface 406. In a preferred embodiment, the monitoring component is a separate docker container. The server may further comprise containers for speech-to-text transcription, natural language processing and text-to-speech transition, respectively. The server may further comprise a controller. The containers may communicate through a private internal network. The system 400 is configured to execute the methods of all above embodiments.

What is claimed is:

1. A method for monitoring performance of a voice recognition (VR) assistance system in a data sensitive environment, wherein the VR assistance system comprises one or more client devices and a server, the server comprising a monitoring component, the method comprising:
determining, by at least one client device of the one or more client devices, client input data;
processing, by the VR assistance system, the client input data;
determining, by the monitoring component, one or more anonymized performance indicators of the VR assistance system;
determining, by the monitoring component, one or more anonymized performance indicator values for the one or more anonymous performance indicators during the processing of the client input data; and
at least one of outputting or saving, by the monitoring component, the determined one or more anonymized performance indicator values.

2. The method of claim 1, wherein the one or more anonymous performance indicators are consistent with predetermined general data protection regulations.

3. The method of claim 1, wherein determining, by the monitoring component, one or more anonymized performance indicator values comprises increasing one or more performance indicator counters, in particular, a plurality of respective counters for a plurality of time intervals.

4. The method of claim 3, wherein the one or more performance indicator counters are indicative of a processing efficiency of the VR assistance system, processing time of the VR assistance system, reply performance of the VR assistance system, processing errors of the VR assistance system, a capacity of the one or more client devices, a power usage of the one or more client devices, a capacity of the server, or a power usage of the server.

5. The method of claim 3, wherein the one or more performance indicator counters are indicative of a usage behavior of the one or more client devices, a request intensity of the one or more client devices, one or more client input data types, software performance of the one or more client devices, or hardware performance or the one or more client devices.

6. The method of claim 4, wherein the one or more performance indicator counters are indicative of an occurrence of a language of the client input data.

7. The method of claim 1, further comprising:
comparing, by the monitoring component, the one or more anonymized performance indicator values to one or more previously determined anonymized performance indicator values or one or more previously determined performance indicator threshold values.

8. The method of claim 1, further comprising:
generating, by the VR assistance system, client output data based on the processed client input data;
outputting, by the at least one client device, the client output data; and
deleting, by the VR assistance system, the client input data and the client output data.

9. The method of claim 1, wherein the monitoring component is comprised in a separate docker container on the server.

10. The method of claim 1, wherein the VR assistance system is a multi-language VR assistance system.

11. A monitoring component for use in a voice recognition (VR) assistance system, wherein the monitoring component is configured to:
determine one or more anonymized performance indicators of the VR assistance system;
determine one or more anonymized performance indicator values for the one or more anonymous performance indicators during processing of client input data by the VR assistance system; and
at least one of output or save the determined one or more anonymized performance indicator values.

12. The monitoring component of claim 11, wherein the one or more anonymous performance indicators are consistent with predetermined general data protection regulations.

13. The monitoring component of claim 11, wherein to determine one or more anonymized performance indicator values comprises to increase one or more performance indicator counters.

14. The monitoring component of claim 13, wherein to increase the one or more performance indicator counters comprises to increase a plurality of respective counters for a plurality of time intervals.

15. The monitoring component of claim 13, wherein the one or more performance indicator counters are indicative of a processing efficiency of the VR assistance system, a processing time of the VR assistance system, a reply performance of the VR assistance system, processing errors of the VR assistance system, a capacity of a client device, a power usage of a client device, a capacity of a server, or a power usage of the server.

16. The monitoring component of claim 13, wherein the one or more performance indicator counters are indicative of a usage behavior of a client device, a request intensity of the client device, one or more client input data types, software performance of the client device, or hardware performance or the client device.

17. The monitoring component of claim 11, wherein the monitoring component is further configured to compare the one or more performance indicator values to one or more previously determined performance indicator values or one or more previously determined performance indicator threshold values.

18. The monitoring component of claim 11, wherein the monitoring component is comprised in a separate docker container on a server.

19. A voice recognition (VR) assistance system, the VR assistance system comprising: one or more client devices; and
a server, the server comprising a monitoring component;
wherein the monitoring component is configured to perform a method comprising:
processing client input data of at least one of the one or more client devices;
determining one or more anonymized performance indicators of the VR assistance system;
determining one or more anonymized performance indicator values for the one or more anonymous performance indicators during the processing of the client input data; and
at least one of outputting or saving the determined one or more anonymized performance indicator values.

20. The VR assistance system of claim 19, wherein the one or more anonymous performance indicators are consistent with predetermined general data protection regulations.
